(19) United States
(12) Patent Application Publication
(10) Pub. No.: US 2016/0041567 A1
(43) Pub. Date: Feb. 11, 2016

(54) Gas Turbine Generation System

(71) Applicant: HITACHI, LTD., Tokyo (JP)

(72) Inventors: Aung KO THET, Tokyo (JP); Tomomichi ITOU, Tokyo (JP); Noriaki HINO, Tokyo (JP); Naohiro KUSUMI, Tokyo (JP); Tetsuro MORISAKI, Tokyo (JP); Kazuo TAKAHASHI, Tokyo (JP)

(73) Assignee: Hitachi, Ltd., Chiyoda-ku, Tokyo (JP)

(21) Appl. No.: 14/781,834

(22) PCT Filed: Apr. 5, 2013
(86) PCT No.: PCT/JP2013/061002

§ 371 Date: Oct. 1, 2015

(51) Int. Cl. G05F 1/12; F01D 15/10

(52) U.S. Cl. CPC G05F 1/12; F01D 15/10; F05D 2220/76

(57) ABSTRACT

A gas turbine generation system has a three-phase generator whose rotor is mechanically coupled to a gas turbine. The system comprises a three-phase voltage balancing circuit having elements independently operable for each phase to disperse or cancel unbalanced components of three-phase current, during unbalanced fault in a power grid connected to the generator, result in balancing of the three-phase voltage; and the voltage balancing constitutes a mechanism of avoiding the occurrence of the rotor vibration from mechanical resonance points on turbine blades.

### TECHNICAL FIELD

The present invention relates to a stability improvement of a gas turbine generation system, especially to a mechanism for avoiding the mechanical resonance points on turbine blades of a rotor thereof to get Fault-Ride-Through (hereafter it's called as “FRT”).

### BACKGROUND ART

Nowadays, as grid connected power generation moves forward, integration of the electricity generation from renewable resources energy into power systems is increasing in addition to the conventional type generation system such as atomic power generation, a gas turbine generation, and hydraulic power generation. As the renewable energy resources have uncertainty nature, the electricity generation from renewable energy resources has the characteristics of output power fluctuation which causes the impacts on the power systems stability. In order to mitigate the impact of output power fluctuation, conventional type generators in power systems become to have the fast load-following capability. In addition to the conventional pump-water storage hydro generator, high-speed turbine generators such as a gas turbine generator, steam turbine generator, can satisfy for fast load-following capability. Gas turbine generator system is one of the best generator systems to smoothen the fluctuation.

Renewable energy generators; such as wind turbine generator and photovoltaic generation systems, are required to fulfill the FRT capability which asks for continuous operation of such generators in the event of voltage dip followed by the grid fault.

A prior art in this technical field is disclosed in US2011/0101927A1. This publication describes that a power generation system includes a generator mechanically coupled to a turbine to generate electrical power. The system includes an FRT system having a three-phase variable resistor and a three-phase variable inductor. The input signal of the three-phase resistor is only one and three resistors as the three-phase variable resistor are controlled at the same time by the same only-one input signal. The variable resistor for each phase is connected in parallel across output terminals of the generator to absorb power from the generator during a grid fault condition, and the variable inductor is connected in series with the generator between an output terminal of the generator and a power grid. In this prior art, a controller for the variable resistor and the variable inductor receives a voltage signal from the grid and a speed signal from the generator to monitor the grid condition. The controller uses these signals to provide control signal to control the resistance value of the variable resistor. When there is a fault in the grid, the voltage at the point of connection of the generator drops significantly, and thereby the variable inductor is activated. The inductor is controlled to provide sufficient inductance during grid fault events, and thereby the variable resistor would consume all the power generated by the generator. Thus the generator is able to keep its rotational speed in an acceptable range resulting in prevention of loss of synchronism and get an FRT.

The FRT intended by US2011/0101927A1 is to get a low voltage ride through (LVRT) for a small generator to prevent the loss of synchronism due to the voltage drop in short period by means of the variable resistor in three-phase to absorb the power with the help of variable inductor to develop the voltage on that variable resistor.

Regarding other prior arts in this technical field:

JP2001-8497A discloses that a system stabilizer device of a synchronous generator control system generates a control signal relating to an automatic voltage regulator device to suppress an effective power deviation, a rotational speed deviation, and a phase difference deviation, which are based on the deviation of effective power measured by a power measuring instrument, on a deviation of the rotational speed measuring instrument of a turbine shaft, on a deviation of the phase difference between output voltage to a side of an electric power system of a main transformer and an internal phase difference angle of a synchronous generator, and thereby the output of the generator is stabilized.

JP2007-28835A discloses of a control system of a field current which can obtain satisfactory transient stability by removing the influence of a large disturbance to be generated at the time of an accident of a grid fault. Concretely, a voltage adjustment device is controlled so that a grid power voltage is kept in a constant voltage through a field magnetic current fed into a field magnetic coil of a generator.

JP-H-10-42588A discloses that a variable speed generator is driven by a control device for a secondary excited motor. The variable speed generator is the one that its rotor namely a secondary side is excited by an AC current with a variable frequency. This prior art discloses that, when the variable speed generator is operated under the unbalanced voltage conditions of the grid, especially even under the unbalanced voltage conditions with negative phase sequence component at an earth fault, it is possible to do the power generation with stability by operating the variable speed generator with output of an accurate fundamental wave or compensation for the negative sequence component. This publication describes that the negative sequence component induces double frequency component of the commercial power voltage.

JP2003-180098A discloses that, when the grid fault occurs in a variable speed pumped-storage generation, the operation of generation continues by using a signal from a voltage reference generation device.

In general, the grid fault can be categorized as balanced fault and unbalanced fault. The unbalanced fault is the most common in power systems. Under the grid unbalanced fault condition, negative phase sequence currents are flowing from the power system. Those currents produce a magnetic field in the generator that rotates in the opposite direction to the rotor. The relative motion of the rotor and the magnetic field induces double frequency currents (100 Hz for 50 Hz power systems) in the rotor surface that can be particularly high and causing the vibration of rotor.

### PRIOR ART DOCUMENTS

### Patent Document

Patent Document 1: US2011/0101927A1

Patent Document 2: JP2001-8497A

Patent Document 3: JP2007-28835A

Patent Document 4: JP-H-10-42588A

Patent Document 5: JP2003-180098A

### SUMMARY OF INVENTION

### Technical Problem

A conventional gas turbine generator does not have FRT capability yet. However, as grid connected renewable energy generation moves forward, the conventional type fast load-following generators such as a gas turbine generator should also have the same capability of continuous operation (FRT) under the grid fault as the renewable energy resources, in order to stabilize the grid.

The present application's inventors studied about problems to be an obstacle to development for FRT of the gas-turbine generators, as its result, they noticed that the conventional gas turbine generators have the following a gas turbine-specific unique problem.

High-speed turbine generators such as gas turbine generators consist of many blades on rotors and they have many mechanical resonance points. Under the grid faulted condition, severe electromagnetic torque vibration will appear. If the severe torque vibration cannot be sufficiently damped, the turbine blades will experience violent swaying motions which cause the vibration. If this vibration excites the mechanical resonance points, the fatigue and possibility to shaft cracks and blade root cracks will be occurred.

This invention is for solving the above mentioned problem; protecting the turbine from vibration caused by the unbalanced fault conditions.

### Solution to Problem

As the negative phase sequence current due to the unbalanced fault causes the double frequency torque vibration, the turbine generation system has a reduction method of this negative phase sequence current by using voltage balancing circuits to flow current unequally to each phase. To solve the foregoing problem, the present invention includes is basically constituted by the followings.

One thereof is a gas turbine generation system having a three-phase generator whose rotor is mechanically coupled to a gas turbine, and the system comprising:

a three-phase voltage balancing circuit having elements independently operable for each phase to disperse or cancel unbalanced components of three-phase current, during unbalanced fault in a power grid connected to the generator, result in balancing of the three-phase voltage; and the voltage balancing constitutes a mechanism of avoiding the occurrence of the rotor vibration from mechanical resonance points on turbine blades.

Another thereof is a method of avoiding the occurrence of the rotor vibration in a gas turbine generator from mechanical resonance points on turbine blades during operation of the generator, by dispersing or cancelling unbalanced components of three-phase current, during unbalanced fault in a power grid connected to the generator, with a three-phase voltage balancing circuit having elements independently operable for each phase.

Although specific terms are employed herein and claims, they are used in a generic and descriptive sense only and not for purposes of limitation.

For example, the three-phase voltage balancing circuit includes: sensors to measure voltage or current for each phase at the generator terminal side or at the generator terminal side, wherein they can be placed at the transformer terminals of grid side also; a controller which detects the unbalance component in the measured voltage or current and then calculates the respective compensative impedance for three phases to distribute unequally to the each phases; voltage balancing circuits means the circuits which have the characteristics of dissipation the electrical power in its impedance and causing voltage variation according to the current flowing in, wherein they are connected to each phase at generator terminal and have semiconductor switching devices; semiconductor switching devices which include power electronics equipments such as thyristor, insulated-gate bipolar transistor (IGBT), wherein these devices can be also existed in any kind of electrical energy conversion system called converter; switching logic block which determines the switching pattern according to configurations of voltage balancing circuits; signal lines connecting the voltage or current sensors to the controller for unbalance component detection; signal lines connecting the controller to the switching logic block; electrical connecting between the switching device and voltage balancing circuits.

For example, the said balancing method for mitigating the unbalanced grid fault impact on the turbine generator uses the semiconductor switching devices (as example, thyristors or IGBT) to set the variable resistor according to the calculated impedance value in the case of voltage balancing circuit is variable resistors. This balancing method is not limited to the use with variable resistors. This can be used to command the converter to supply the unequal currents at each phase in the case of switching devices are composed as converter.

### Advantageous Effects of Invention

With this invention, turbine rotor vibration which can excite the mechanical resonance points under the grid unbalanced fault condition can be reduced. Therefore, the fatigue and possibility to shaft cracks and blade root cracks will be reduced and FRT capability of turbine generator can be improved.

### BRIEF DESCRIPTION OF DRAWINGS

FIG. 1 is brief description of the preferred embodiment 1 in the invention;

FIG. 2 is an outline of invention for the embodiment 1;

FIG. 3 is a parallel configuration of variable resistors at phase a;

FIG. 4 is a simulated graph to illustrated the negative sequence current reducing;

FIG. 5 is a simulated graph to illustrated the vibration reducing;

FIG. 6 is an outline of invention for the preferred embodiment 2;

FIG. 7 is the configuration of a converter system the embodiment 2;

FIG. 8 is the details configuration of power electronics module as the converter.

FIG. 9 is a block diagram of the controller used in the embodiment 2.

### DESCRIPTION OF EMBODIMENTS

A preferred embodiment of the present invention will be described.

### Example 1

In this embodiment, explained is a turbine generator system [1] in which variable resistors with thyristor switching devices [101] is provided to mitigate the vibration impact on a gas turbine's [3] blades and a generator's [4] rotor due to an unbalanced grid fault in a grid [2] in which a gas turbine generator [4] is connected.

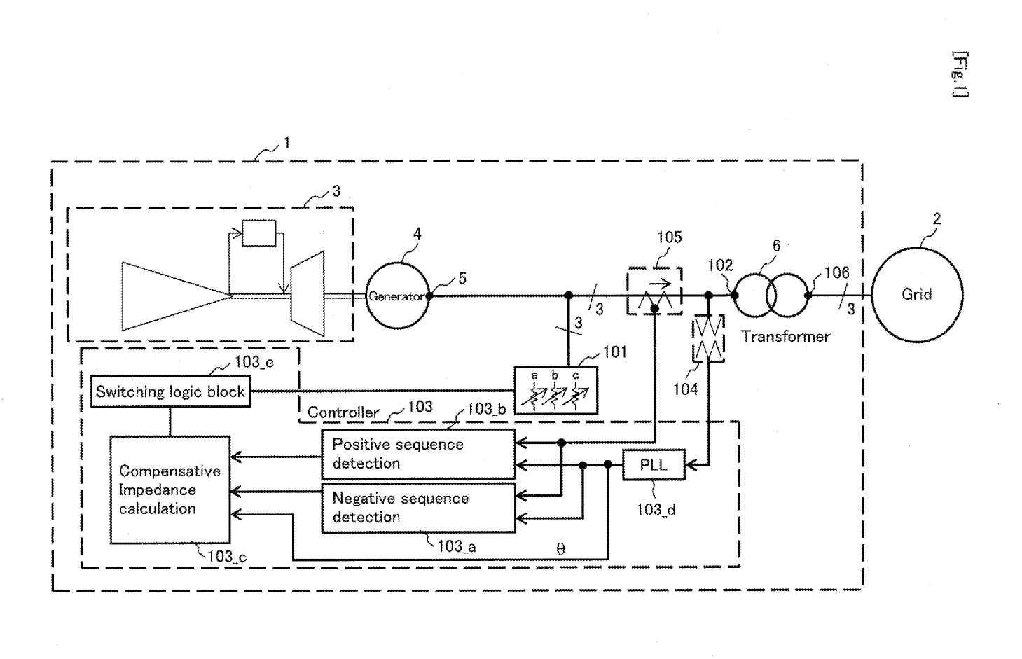

FIG. 1. illustrates the outline of the embodiment 1 of invented turbine generator system [1]. Main circuit of the turbine generation system comprises a gas turbine[3], a three-phase generator [4], a transformer [6], and variable resistors [101]. The gas turbine[3] compresses inlet air by its compressor and mixes the compressed air and fuel. A combustor inside the gas turbine[3] burns the mixture and supplies expansion force to the turbine. With the expansion force, the turbine gets rotating torque. The compressor and the turbine are mechanically connected by a shaft and a part of rotating torque is supplied from the turbine to the compressor. With this rotating torque, the compressor can get power to compress the inlet air. The shaft of gas turbine[3] is also mechanically connected to the generator [4] and the gas turbine supplies rotating torque to the rotor inside the generator [4]. By receiving the rotating torque from the gas turbine[3], the generator [4] generates electric power. Stator terminals [5] of the generator [4] are electrically connected to generator-side terminals [102] of the transformer [6] and the transformer is connected to the grid [2]. Generated electric power from the generator [4] is sent to the grid [2] via the transformer [6].

From now on, The unique point of the turbine generation system [1] is explained with figures.

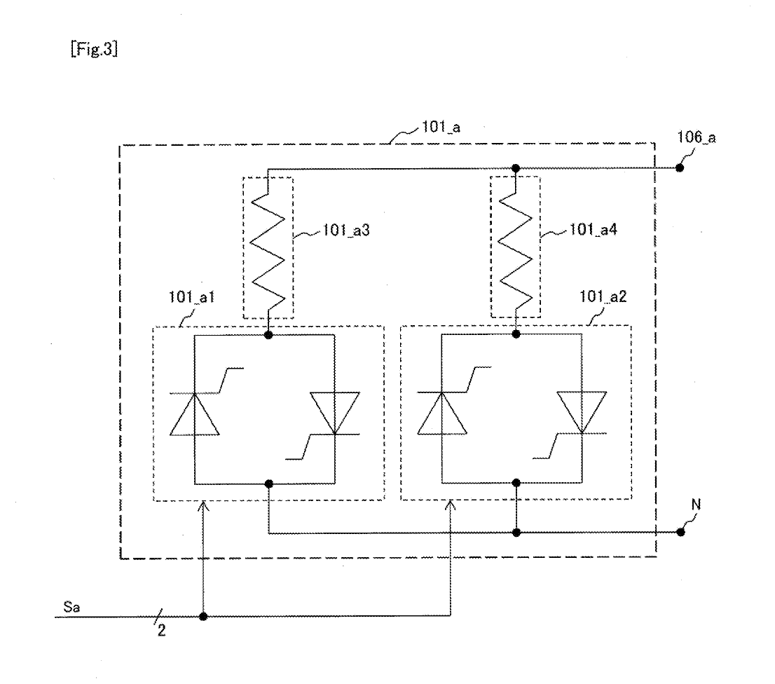

In the unique point, variable resistors [101] are also electrically connected to stator terminals of generator [4], respectively. Those variable resistors [101] include thyristor switching devices (refer to FIG. 3) to reduce the impact of unbalanced fault in the grid [2] on the gas turbine[3]. The variable resistors [101] are placed between the generator's stator terminal [5] and the grid [2] connected the transformer [6].

Those variable resistors [101] are electrically connected to each phase of the generator terminals [5] in parallel and their resistance can be changed by a logic block [103_{—}e] of a controller [103] by making turn-on or turn-off the attached thyristor switch. The operation of those thyristor is determined by the signal from the controller [103].

The controller [103] has a negative sequence detection block [103_{—}a], a positive sequence detection block [103_{—}b], a compensative impedance calculation block [103_{—}c], and a Phase Locked Loop (PLL) [103_{—}d]. Input signals of this controller [103] are line to line voltage and current which are measured by voltage sensors [104] and current sensors [105], respectively.

The voltage sensors [104] and the current sensors [105] are connected at generator-side transformer's terminals [102].

When the fault at the grid side is occurred, the controller [103] calculates balanced and unbalanced components in the sensed current with the current sensor [105] at each phase. Concretely speaking, the controller calculates positive sequence component and negative sequence component for each phase in the sensed current signals. The balanced component is from the positive sequence component, and the unbalanced component is from the negative sequence component. So, calculating the positive sequence is equal to detect the balanced component and calculating the negative sequence component is equal to detect the unbalanced component. The positive sequence component and the negative sequence component of the current are detected by calculation in the portion of [103_{—}a] and [103_{—}b] respectively. Once the positive and negative sequence components are detected, the controller [103] calculates the required impedance for compensating the unbalanced current in the portion of [103_{—}c]. According to the output signal of compensative impedance calculation block [103_{—}c], a switching logic block [103_{—}e] set the thyristor switches in variable resistors block [101] based on the configuration of those variable resistors [101] which are pre-determined in the switching logic block [103_{—}e].

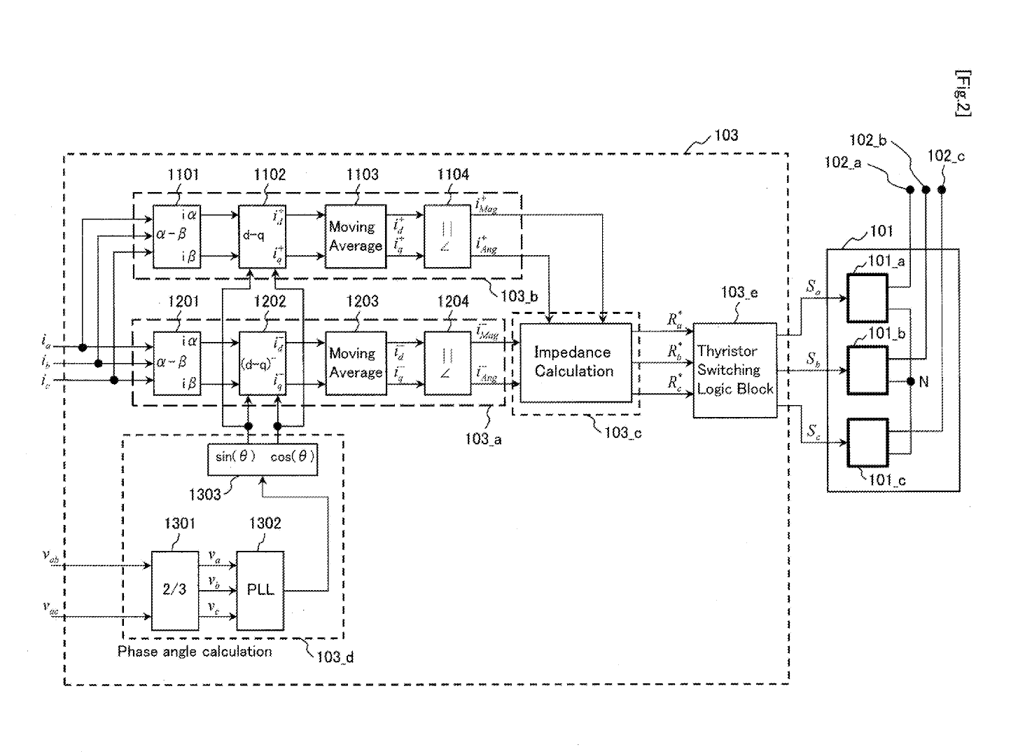

Detailed calculations inside the controller [103] are explained with FIG. 2.

FIG. 2 shows a block diagram of the controller [103] and the variable resistors [101]. The Controller [103] comprises the positive sequence detection block [103_{—}b], the negative sequence detection block [103_{—}a], the phase detecting block [103_{—}d], the compensative impedance calculation block [103_{—}c] and the thyristor switching logic block [103_{—}e]. Three sensed currents iₐ, i_{b}, i_{c}, of transformer [6] and two sensed line-to-line voltages v_{ab}, v_{bc}, are used as inputs.

Phase locked loop as PLL block [103_{—}d] inputs the line-to-line voltages v_{ab} and v_{bc} and calculates the phase angle of the voltage at the generator-side transformer terminals [102]. Concretely speaking, line-to-line voltages are converted into phase voltages va, vb, and vc by the phase voltage calculator [1301]. The PLL block inputs the phase voltages va, vb, and vc and calculates phase angle θ. PLL calculation is well known in this field, so explanation of the calculation is skipped here.

The phase angle θ is sent to a Sin-Cos table [1303] and the impedance calculation block [103_{—}c]. The Sin-Cos table [1303] outputs sin and cosine waveforms corresponding to the input phase angle θ. The calculated sinusoidal waveforms are sent to block [1102] and [1202]. The waveforms are used to execute d-q transformation and inverse d-q transformation of the detected currents.

Currents ia, ib, ic are come from the sensors [105] and converted into positive sequence components and negative sequence components. The positive sequence components are calculated in the [103_{—}b] and the negative components are calculated in the [103_{—}a]. Those positive and negative sequence currents are used for impedance calculation in block [103_{—}c].

Calculation in 103_{—}a and 103_{—}b are explained in detail.

There phase currents iₐ,i_{b},i_{c}, are transformed from 3 phase to 2 phase axis by using the α-β transformation in block [1101]. The calculation can be done by [MATH 1]. The currents in α-β axis are transformed into positive sequence in d-q axis by using the d-q transformation [1102] by means of [MATH 2]. When the phase current contains negative sequence components or harmonic components, the components appears in id+ and iq+ as fluctuating components. The positive sequence components which are transformed into DC are extracted with the help of a moving average filter [1103] over a period of one electric power frequency cycle, T[sec]. These positive sequence components are transformed into magnitude and angle. This is done in [1104] which are represented by [MATH 3]. The output of block [1104] is used in impedance calculation [103_{—}c].

$$\begin{matrix}[ \begin{matrix}i α \\ i β\end{matrix} ] = \frac{2}{3} [ \begin{matrix}1 & - 1 / 2 & - 1 / 2 \\ 0 & \sqrt{3} / 2 & - \sqrt{3} / 2\end{matrix} ] [ \begin{matrix}iu \\ iv \\ iw\end{matrix} ] & [ MATH 1 ] \\ [ \begin{matrix}{i}_{d}^{+} \\ {i}_{q}^{+}\end{matrix} ] = [ \begin{matrix}cos θ s & sin θ s \\ - sin θ s & cos θ s\end{matrix} ] [ \begin{matrix}i α \\ i β\end{matrix} ] & [ MATH 2 ] \\ \begin{matrix}{i}_{Mag}^{+} = \sqrt{{( {i}_{d}^{+} )}^{2} + {( {i}_{q}^{+} )}^{2}} \\ {i}_{Ang}^{+} = {tan}^{- 1} ( \frac{{i}_{q}^{+}}{{i}_{d}^{+}} )\end{matrix} & [ MATH 3 ]\end{matrix}$$

The negative sequence components are calculated in the [103_{—}a] for unbalanced fault detection. Three-phase currents iₐ,i_{b},i_{c}, are transformed from 3 phase to 2 phase axis by using the α-β transformation in block [1201]. The calculation can be done by [MATH 4]. The currents in α-β axis are transformed into negative sequence in d-q axis by using the inverse d-q transformation[1202] by means of [MATH 5]. As the positive sequence and harmonic components appears in the id- and iq- as fluctuating components, the negative sequence components which are transformed into DC are extracted with the help of a moving average filter [1203] over a period of one electric power frequency cycle,T[sec]. These negative sequence components are transformed into magnitude and angle. This is done in [1204] which are represented by [MATH 6]. The output of block [1204] is used for unbalanced fault current detection in impedance calculation block [103_{—}c].

$$\begin{matrix}[ \begin{matrix}i α \\ i β\end{matrix} ] = \frac{2}{3} [ \begin{matrix}1 & - 1 / 2 & - 1 / 2 \\ 0 & \sqrt{3} / 2 & - \sqrt{3} / 2\end{matrix} ] [ \begin{matrix}iu \\ iv \\ iw\end{matrix} ] & [ MATH 4 ] \\ [ \begin{matrix}{i}_{d}^{+} \\ {i}_{q}^{+}\end{matrix} ] = [ \begin{matrix}cos θ s & - sin θ s \\ sin θ s & cos θ s\end{matrix} ] [ \begin{matrix}i α \\ i β\end{matrix} ] & [ MATH 5 ] \\ \begin{matrix}{i}_{Mag}^{-} = \sqrt{{( {i}_{d}^{-} )}^{2} + {( {i}_{q}^{-} )}^{2}} \\ {i}_{Ang}^{-} = {tan}^{- 1} ( \frac{{i}_{q}^{-}}{{i}_{d}^{-}} )\end{matrix} & [ MATH 6 ]\end{matrix}$$

The magnitude and angle of positive and negative components are used as input to determine the compensative impedance in block [103_{—}c]. Information of positive sequence components from block [1104] and negative sequence components [1204] are compared to determine which phases to be inserted resistor and value of resistance also. This is done by matching the pre-determined table in block [103_{—}c] which is constructed in advance based on the characteristic of generator [4] and connected grid [2], and then block [103_{—}c] outputs the unequal resistance value Rₐ*,R_{b}*,R_{c}*, in order to reduce the unbalanced fault impact on the turbine inside gas turbine[3] by dissipating the unequal currents in each phase.

In the switching control logic [103_{—}e], the specifications and configuration of variable resistors with thyristor switching devices [101] is set in advance and the appropriate gates switching is done accordingly. As those gates switching is done unequally at each phase and letting to flow unbalanced current at each phase by means of unequal resistance, the unbalanced components in 3 phase current at generator stator terminals [5] are reduced. This will reduce the impact on the turbine rotor which is caused by the unbalanced current.

The variable resistors block [101] comprises three groups of paralleled resistors with antiparallel thyristor switches at phase a, phase b, and phase c as [101_{—}a], [101_{—}b], [101_{—}c] which are connected to the each phase of stator terminals [5_{—}a], [5_{—}b], and [5_{—}c], respectively. The resistors in those groups have the anti-parallel thyristor switches and have the same characteristics with same star configuration.

FIG. 3 illustrates the parallel configuration of variable resistors at phase a [101_{—}a]. In this embodiment, the vector of switching signals Sa consists of two firing signals for the thyristor pairs [101_a1] and [101_a2]. The switching signal vector Sa is used to turn-on or turn-off the antiparallel thyristor switchs [101_a1] and [101_a2]. According to the states of those switches, the current from the connection point [106_{—}a] is flowed through in resistors [101_a3] and [101_a4] to the neutral point, N. The amount of flowed current varies according to the numbers of resistors in parallel configuration and switching state of the associated thyristor. Doing the same approach in other phases; phase a and phase b, three-phase unbalanced current can be reduced at generator side terminal [102].

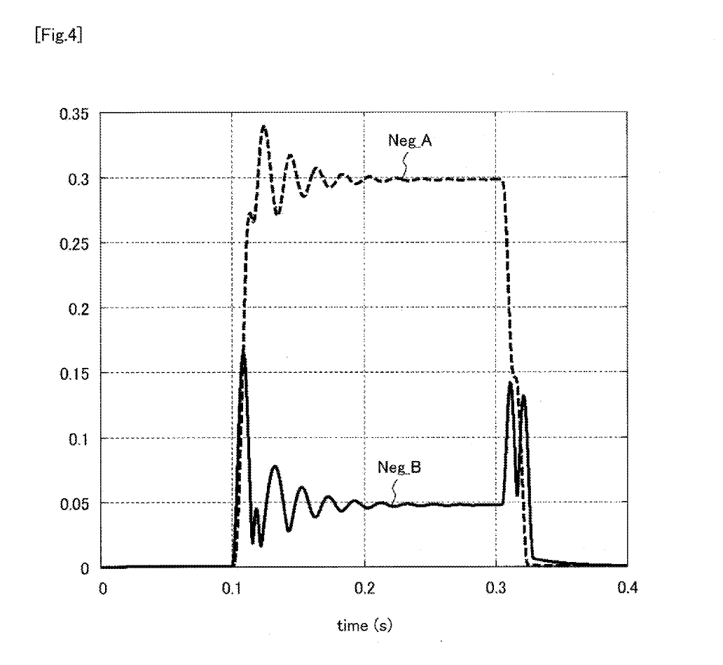

FIG. 4 is a simulated result to show the effectiveness of this invention. In this case, a fault is occurred at phase a. The resistors are inserted to phase b and phase c to reduce the unbalanced current. The simulation result is compared with the based case; without the use of this invention. Comparing to Neg_A which is without the use of this invention, we can said that negative sequence current, as shown by Neg_B, can be significantly reduced by using this invention.

In this embodiment, the current sensor [105] and voltage sensor [104] is installed at the generator-side terminals of the grid connecting transformer [6]. But the positions of the current sensors [105] and the voltage sensors [104] are not limited to generator side [102] but can be placed at grid side [106]. The locations of those sensors [104], [105] and configuration of resistors have influence on the pre-determined table in [103_{—}e] and therefore, Pre-determined table in the Impedance Calculation block [103] has data which match the grid-side current and grid-side voltage.

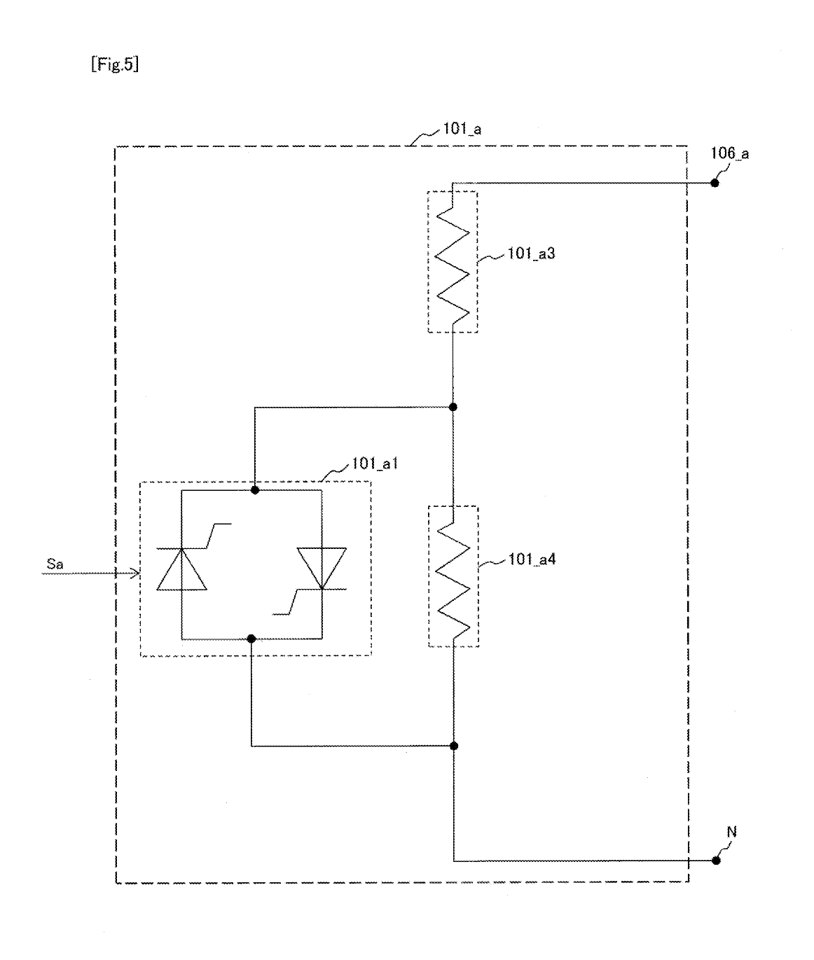

In this embodiment, number of parallel connection of the variable resistor per phase is two. But the number can be three or more if the anti-paralleled thyristor switches are connected to the resistors. In this embodiment, configuration of the variable resistor has parallel connection of the resistors and thyristor switches. But the configuration can be series-connection as shown in the FIG. 5.

### Example 2

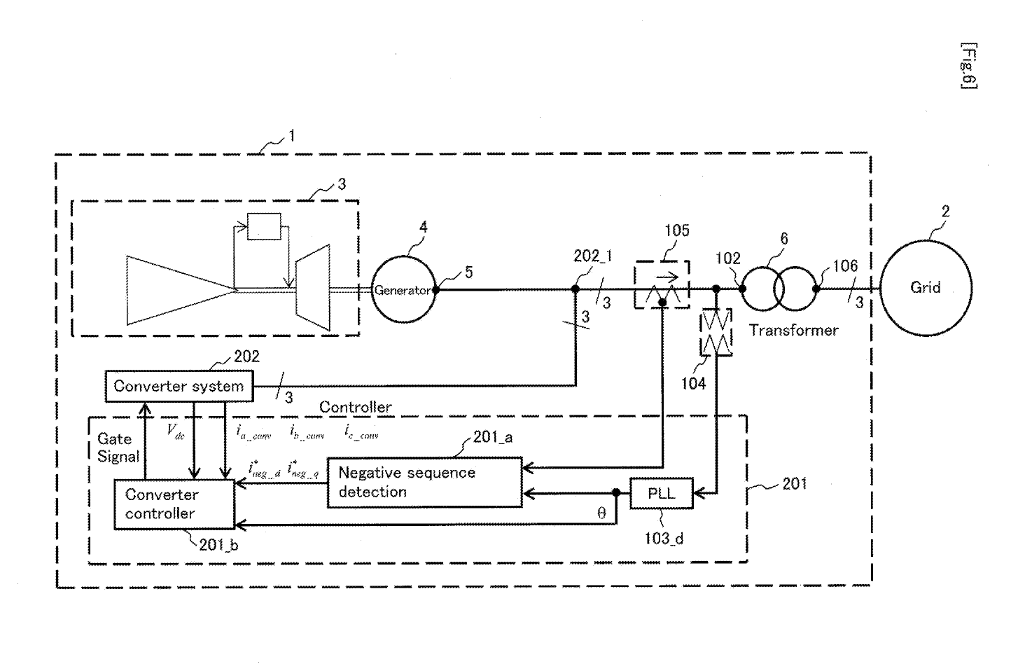

In this embodiment, the preferable configuration of the invented turbine generation system [1] is explained by using FIG. 6. The difference between the turbine generation system shown in the preferred embodiment 1 and turbine generation system shown in FIG. 6 is the use of a converter instead of variable resistors and the converter outputs currents including negative sequence component in order to reduce the negative sequence component in the output current from generator 4. For the components which have the same configuration as shown in the preferred embodiment 1 are represented with the same numbers and so the detailed explanation of those components are skipped here.

From now on, the unique point of the embodiment 2 is explained with figures. The unique points is that the converter system [202] is controlled by a controller [201] with the current detection at the transformer terminals [102] by the current sensors [105] which calculates the negative sequence component in a block [201_{—}a] to add compensating references on the output current references at a converter controller [201_{—}b] to reduce the impact of unbalanced fault in the grid [2] on the gas turbine[3]. The converter [202] is placed at a point [202_1] between the stator terminal [5] of the generator [4] and the generator-side transformer terminal [102] for each phase. The converter controller sets the converter [202] to supply the negative sequence current at connection point [202_1] which is electrically connected with generator's terminal [5]. With this control, the negative sequence current is supplied to the grid [2] by the converter [202] and hence, the negative sequence current at the generator [4] which causes the vibration in the turbine[3] can be reduced.

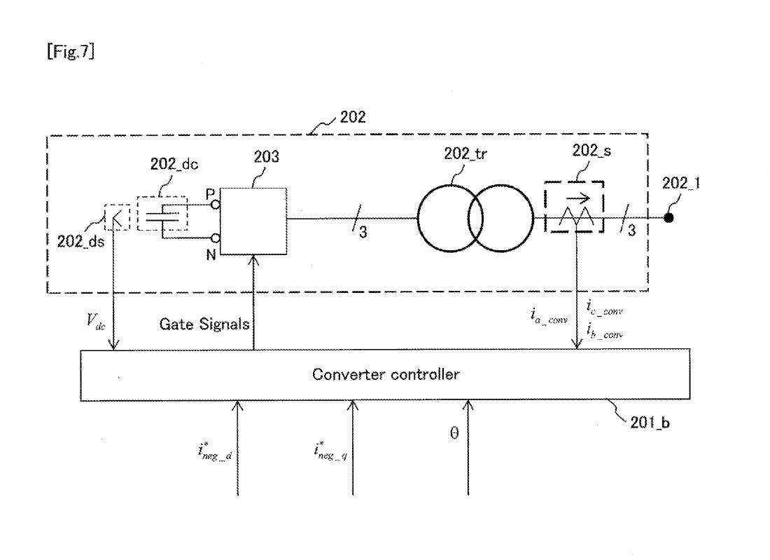

FIG. 7 illustrates the configuration of the converter system [202] which includes the power electronics module, called converter [203], capacitor 202_{—}dc which is connected to the converter [203] at DC-link terminals of P and N, current sensors [202_{—}s] to measure the converter current iₐ_{_{—}}_{conv},i_{b}_{_{—}}_{conv},i_{c}_{_{—}}_{conv}, and dc voltage sensor [202_{—}ds] to measure the dc-capacitor [202_{—}dc]. The output of sensors [202_{—}s] and [202_{—}ds] are used as input of converter controller [201_{—}b]. As explained briefly above, the controller [201_{—}b] inputs the compensating current references ineg_d and ineg_q from the block [201_{—}a]. The controller [201_{—}b] calculates gate signals of the converter [202].

The converter controller [201_{—}b] sends the gate signals to do switching operations of power electronics switches such as Insulated-Gate-Bipolar-Transistor (IGBT) inside the converter [203].

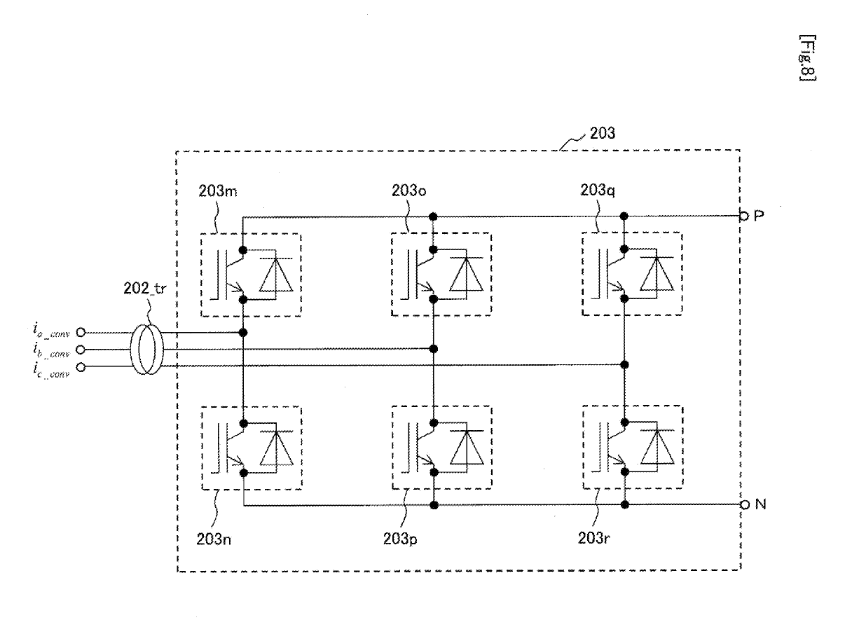

FIG. 8 shows the details configuration of power electronics module as the converter [203]. The power electronics module [203] has a configuration of a voltage-source 2-level inverter. In this embodiment, the two-level configuration of converter with the six IGBTs; [203m], [203n], [203o], [203p], [203q], [203r] are used. By changing the duty ratio of the IGBTs, the power electronics module [203] can control output voltage. The power electronics module [203] can control the output current iₐ_{_{—}}_{conv}, i_{b}_{_{—}}_{conv}, and i_{c}_{_{—}}_{conv} with proper control algorithm explained later. The configuration of the converter is not limited to two-level but also can be used multi-level configuration. The use of the transformer [202_{—}tr] can be also eliminated in the case of the voltage level at the generator terminal [5] is within the acceptable range based on the characteristic of the power electronics switches and configuration of converter.

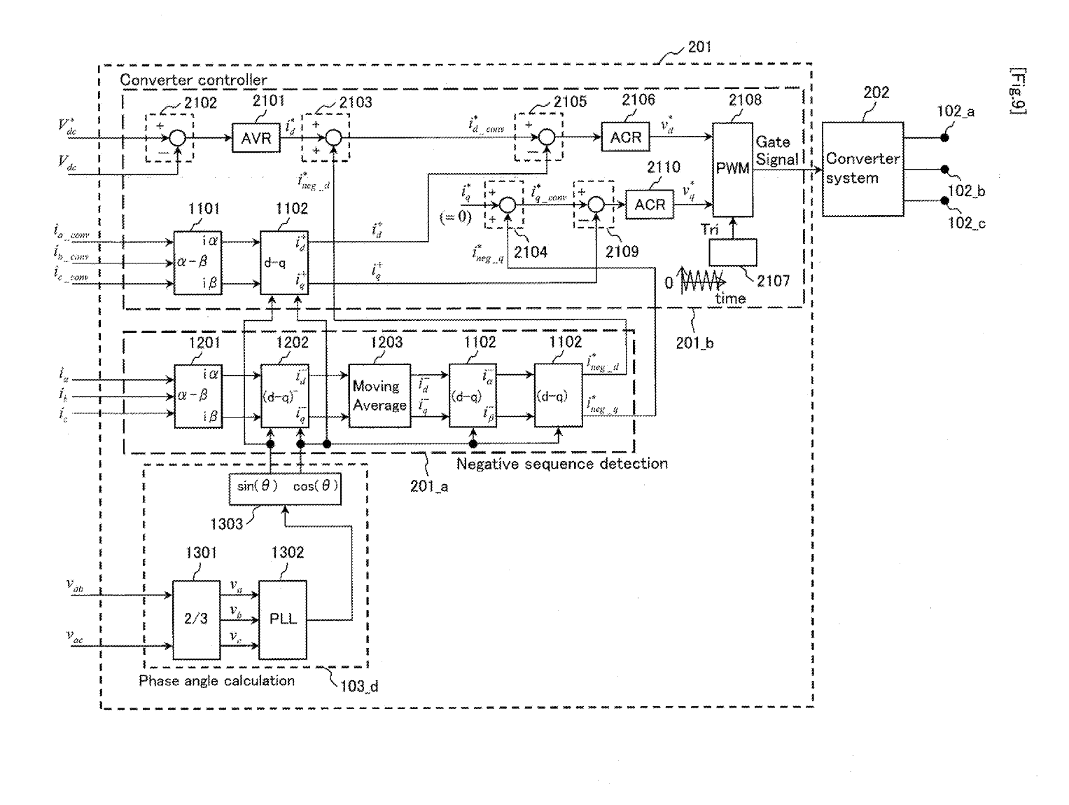

Calculations in the controller [201] are explained with FIG. 9. The controller [201] has two main functions; a) Direct Current (DC) link voltage stabilization, b) negative sequence current compensation control. In normal operation, the converter's DC link voltage V_{dc} is stabilized by converter controller [201_{—}b]. This invention modifies the conventional converter controller by adding the negative sequence references i_{neg}_{_{—}}_{d}*, i_{neg}_{_{—}}_{q}*, to the control references of normal operation i_{d}*, i_{q}*.

The inputs of the controller [201] are the currents ia_conv, ib_conv, ic_conv which are measured by the current sensor [202_{—}s] at the connection point [202_1], the currents ia, ib, is which are measured by the current sensor [105] at the terminal of the generator-side transformer [102], the DC-link voltage Vdc at the converter [202] measured by the voltage sensor [202_{—}ds], and line to line voltages vab, and vbc measured by the voltage sensors [104].

Detailed calculations inside the controller [201] are explained with FIG. 9. FIG. 9 shows a block diagram of the controller [201] and comprises a negative sequence detection block [201_{—}a], a converter controller [201_{—}b] and a phase angle calculation block [103_{—}d]. In the block of negative sequence detection, the output of a moving average block [1203], i.e. negative sequence in d-q axis, are transformed into phase angle rotation which is equivalent to positive sequence by using the two d-q transformation[1102] blocks. This means that the first d-q transformation[1102] block makes the negative sequence current which is equivalent to the α-β axis and then the second d-q transformation[1102] block makes the negative sequence current which is equivalent to d-q axis where the positive sequence is existing. Therefore, the outputs of the negative sequence detection block [201_{—}a], i_{neg}_{_{—}}_{d}*,i_{neg}_{_{—}}_{q}*, can be added to the control references, i_{d}*, i_{q}*, in a converter controller [201_{—}b]. i_{q}* is set as zero in this embodiment.

In the converter controller, the dc voltage of capacitor, V_{dc}, is controlled by Automatic Voltage Regulator (AVR) [2101] which has a Proportional Integral (PI) comparator, uses output of subtractor [2102] that calculates the difference between the rated dc voltage, V_{dc}*, and measured dc voltage, V_{dc}, of capacitor. Then the output of AVR [2101], i_{d}*, is added with the i_{neg}_{_{—}}_{d}* to make the new reference current in d-axis, i_{d}_{_{—}}_{conv}*, by the adder [2103]. In the similar manner, i_{neg}_{_{—}}_{q}*, is added with i_{q}*, to make the new reference current in q-axis, i_{q}_{_{—}}_{conv}*, by the adder [2104]. Then output current of the converter systems is controlled according to the new reference current in d-axis and q-axis. To control the converter's output current in in d-axis and q-axis, transforming the iₐ_{_{—}}_{conv}, i_{b}_{_{—}}_{conv}, i_{c}_{_{—}}_{conv} into the d-q axis is done by α-β, and d-q transformation blocks; [1101] and [1102], respectively. Then subtractor [2105] calculates the difference between new reference and the converter's output current in d-axis. Then the Automatic Current Regulator (ACR) [2106], which is a Proportional Integral (PI) comparator, sets the reference of converter's voltage in d-axis, v_{d}*. This v_{d}* is compared with the output of triangular wave generator [2107] in block of Pulse-Width-Modulation (PWM) [2108]. The PWM technology is well known in this field and the details are skipped here. In the similar manner, subtractor [2109] calculates the difference between new reference and output current in q-axis. Then the ACR [2110] sets the reference of converter's voltage in q-axis, v_{q}*. This v_{q}* is compared with the output of triangular wave generator [2107] in PWM. Then the PWM output the gate switching signals for converter systems [202] which is connected to the transformer terminals [102_{—}a], [102_{—}b], [102_{—}c]. Then the converter system [202] modulates to supply the negative sequence current. Therefore, the negative sequence current at generator terminals are reduced. This will reduce the impact on turbine rotor which is caused by the unbalanced current.

### REFERENCE SIGNS LIST

1 Scope of this invention
2 Electrical power grid
3 Gas turbine
4 Generator
5 Generator terminal
6 Transformer to connect electrical power grid and generator
101 Variable resistors
101_{—}a Groups of variable resistors at phase a
101_{—}b Groups of variable resistors at phase b
101_{—}c Groups of variable resistors at phase c
102 Transformer terminal at generator side, which is used for connecting electrical power grid and generator
102_{—}a phase a at generator-side transformer's terminal
102_{—}b phase b at generator-side transformer's terminal
102_{—}c phase c at generator-side transformer's terminal
103 Unbalanced fault controller
103_{—}a Negative sequence detection
103_{—}b Positive sequence detection
103_{—}c Compensative impedance calculation
103_{—}d Phase-Locked-Loop (PLL)
103_{—}e Power electronics switching devices
104 Voltage sensors
105 Current sensors
106 Transformer terminal at grid side, which is used for connecting electrical power grid and generator
1101 abc to α-β transformation for positive sequence
1102 α-β to d-q transformation for positive sequence
1103 Moving average filter for positive sequence
1104 d-q to magnitude and angle transformation for positive sequence
1201 abc to α-β transformation for negative sequence
1202 α-β to d-q transformation for negative sequence
1203 Moving average filter for negative sequence
1204 d-q to magnitude and angle transformation for negative sequence
1301 Transformation of line-to-line voltage to phase voltage transformation
1303 sin θ and cos θ calculation table.
201 controller in the case of embodiment 2
201_{—}a Negative sequence detection
201_{—}b converter controller
202 converter system
202_1 converter system's grid connection point
202_{—}tr transformer in converter system
202_{—}s current sensors in converter system
202_dsDC-voltage sensor in converter system
202_dcDC-capacitor for converter
203 Converter
2101 Automatic Voltage Regulator (AVR)
2102 numerical processor
2103 numerical processor
2104 numerical processor
2105 numerical processor
2106 Automatic Current Regulator (ACR) for d-axis current
2107 Triangular wave generator for PWM
2108 Pulse-Width-Modulation (PWM)
2109 numerical processor
2110 Automatic Current Regulator (ACR) for q-axis current

1. A gas turbine generation system having a three-phase generator whose rotor is mechanically coupled to a gas turbine, and the system comprising:
a three-phase voltage balancing circuit having elements independently operable for each phase to disperse or cancel unbalanced components of three-phase current, during unbalanced fault in a power grid connected to the generator, result in balancing of the three-phase voltage; and the voltage balancing constitutes a mechanism of avoiding an occurrence of the rotor vibration from mechanical resonance points on turbine blades.

2. The gas turbine generation system in claim 1, the three-phase voltage balancing circuit comprises:
current sensors coupled to whether turbine generator terminals or grid side of the transformer which is used for the grid interconnecting of the generator, wherein the current sensors detect output current from the generator;
a controller which is connected to the current sensors and calculating compensative references as outputs to switching logics;
semiconductor switching devices which are independently operable, and
the switching logics connected to the semiconductor switching devices to flow the unequal current for three phase according to input of reference value from the controller to make on/off operation of the voltage balancing circuit.

3. The gas turbine generation system of claim 2, wherein the controller coupled to voltage and current sensors and is configured to receive the sensed current and voltage at the transformer.

4. The gas turbine generation system of claim 1, wherein the voltage balancing circuit comprises three-phase resistors and semiconductor switches.

5. The turbine generation system of claim 1, wherein the voltage balancing circuit is composed by a three-phase converter system.

6. The gas turbine generation system of claim 3, wherein the controller uses the input signals from the current sensors and voltage sensors to calculate the positive and negative sequence components by using the transformation of the unbalanced components from three-phase systems to output the reference value for the switching logic which is coupled to the three-phase variable resistors.

7. The gas turbine generation system of claim 6, wherein the controller uses the input signals from the current sensors and voltage sensors to transform positive and negative sequence components of the measured current into magnitudes and angles of the positive sequence and negative sequence as outputs.

8. The gas turbine generation system of claim 7, wherein the controller uses the magnitudes and angles of the positive and negative sequence to calculate, as output, the resistance and phases where the resistors to be inserted.

9. The turbine generation system of claim 8, wherein the controller has a capability of compensative impedance calculation based on predetermined lookup table with the characteristics of the generator and its connected grid.

10. The turbine generation system of claim 6, wherein the controller has a switching control logic in which the specifications and configuration of variable resistors are set in advance and capable to match with compensative impedance to operate the variable resistors.

11. The turbine generation system of claim 1, wherein the voltage balancing circuit includes three groups of variable resistors connected at each phase of generator's stator terminal, having the anti-parallel thyristor switches with same characteristics and configuration.

12. The turbine generation system of claim 2, wherein the controller is coupled to a grid connected converter comprised of the power electronics devices and capacitor, and outputs the values to modify the current references of a converter controller for supplying the unequal current at generator terminal.

13. The turbine generation system of claim 11, further comprising a controller calculates with the use of signals from the sensors as inputs to detect the negative sequence component by using the transformation of unbalanced components from three-phase systems, wherein the controller is coupled to the converter system.

14. The turbine generation system of claim 13, further comprising an additional voltage sensor at the converter's capacitor senses a direct-current-link voltage and inputs to the converter controller.

15. The turbine generation system of claim 14, further comprising the additional current sensors at the terminal of the converter system sense the converter's output current to use as the converter controller′ inputs.

16. The turbine generation system of claim 15, further comprising the adders modified the current references of the converter controller to output the negative sequence component in the current at generator terminal.

17. The turbine generation system of claim 16, further comprising a DC-link voltage regulator regulates the direct-current-link voltage, and current regulators regulate output current of converter with the input of reference valued calculated.

18. The turbine generation system of claim 17, further comprising a pulse-width-modulation (PWM) element coupled to a converter and configured for receiving the control signals from the current regulators.

19. A method of avoiding an occurrence of the rotor vibration in a gas turbine generator from mechanical resonance points on turbine blades during operation of the generator, by dispersing or cancelling unbalanced components of three-phase current, during unbalanced fault in a power grid connected to the generator, with a three-phase voltage balancing circuit having elements independently operable for each phase.

20. The control method of claim 19, wherein the voltage balancing circuit has a group of variable resistors; and the method further comprising:
sensing a grid current with current sensors coupled to whether a turbine generator terminal or grid side of a transformer which is use for grid interconnecting of the generator;
calculating reference values of unequal resistance and associated phase with the predetermined table looking by using the input signals from the current sensors;
matching the reference values of unequal resistance and associated phase with a switching logic based on configuration and characteristics of the variable resistors which are coupled to the terminal of generator and has semiconductor switching devices which are independently operable;
making the variable resistors to flow the unequal phase current at three phase of the generator terminal, according to the switching signal inputs from controller, by on/off operation of semiconductor switching devices so as to reduce the negative sequence current at the generator terminal during the grid unbalance event or fault.

21. The control method of claim 19, wherein the voltage balancing circuit has a converter system; and the method further comprising:
providing a converter controller with voltage sensor at direct current link of converter's capacitor, current sensors at converter system terminal;
sensing a grid current with current sensors coupled to whether a turbine generator terminal or grid side of the transformer which is use for grid interconnecting of the generator;
calculating reference values of output current from the converter system with input signals from said current sensors;
controlling the converter to supply unequal phase current at three phase of the generator terminal depending on said reference values so as to reduce the negative sequence current at the generator terminal during the grid unbalance event or fault.
